(19) United States
(12) Patent Application Publication
(10) Pub. No.: US 2020/0308381 A1
(43) Pub. Date: Oct. 1, 2020

(54) HETEROPHASIC PROPYLENE COPOLYMERS

(71) Applicant: BASELL POLIOLEFINE ITALIA S.R.L., MILANO (IT)

(72) Inventors: GIANNI VITALE, FERRARA (IT); FABRIZIO PIEMONTESI, FERRARA (IT); BENEDETTA GADDI, FERRARA (IT); GIANNI COLLINA, FERRARA (IT); GIAMPIERO MORINI, FERRARA (IT); CAROLINE CATHELIN, FERRARA (IT); MARCO CIARAFONI, FERRARA (IT); GIANPIERO FERRARO, FERRARA (IT); CLAUDIO CAVALIERI, FERRARA (IT); PAOLA MASSARI, FERRARA (IT); MICHELE GRAZZI, FERRARA (IT)

(73) Assignee: BASELL POLIOLEFINE ITALIA S.R.L., MILANO (IT)

(21) Appl. No.: 16/617,403

(22) PCT Filed: May 3, 2018
(86) PCT No.: PCT/EP2018/061306

§ 371 Date: Nov. 26, 2019

(30) Foreign Application Priority Data
May 30, 2017 (EP) 17173388.4

(51) Int. Cl. C08L 23/12; C08F 210/02; C08F 210/06; C08F 2/00; C08F 4/646; C08F 4/649; C08F 4/657

(52) U.S. Cl. CPC C08L 23/12; C08F 210/02; C08F 210/06; C08L 2207/02; C08F 4/6465; C08F 4/6492; C08F 4/6574; C08F 2/001

(57) ABSTRACT

A polypropylene composition made from or containing:
A) from 50 wt % to 90 wt %, based upon the total weight of the polypropylene composition, of a propylene homopolymer; and
B) from 10 wt % to 50 wt %, based upon the total weight of the polypropylene composition, of a copolymer of propylene and ethylene having from 30.0 wt % to 70.0 wt %, based upon the total weight of the copolymer, of ethylene derived units;
   the polypropylene composition having:
i) an intrinsic viscosity of the fraction soluble in xylene at 25° C. between 2.2 and 4.0 dl/g;
ii) a MFR L from 0.5 to 100 g/10 min; and
iii) a xylene soluble fraction ranging from 10 wt % to 50 wt %, based upon the total weight of the polypropylene composition.

### FIELD OF THE INVENTION

In general, the present disclosure relates to the field of chemistry. More specifically, the present disclosure relates to polymer chemistry. In particular, the present disclosure relates to a heterophasic propylene copolymer.

### BACKGROUND OF THE INVENTION

Polypropylene is the material of choice for many applications. Some polypropylene compositions are used in articles in the automotive interior.

### SUMMARY OF THE INVENTION

In a general embodiment, the present disclosure provides a catalyst system containing bismuth and at least one external electron donor compound having the formula:

(R¹)ₐSi(OR²)_{b}

wherein R¹ and R² are independently selected among alkyl radicals with 1-8 carbon atoms, optionally containing heteroatoms, and a is 0 or 1 and a+b=4.

In a general embodiment, the present disclosure provides a polypropylene composition made from or containing:
A) from 50 wt % to 90 wt %, based upon the total weight of the polypropylene composition, of a propylene homopolymer having a fraction insoluble in xylene at 25° C., higher than 90%, and a MFR L (Melt Flow Rate according to ISO 1133, condition L, at 230° C. and 2.16 kg load) from 0.5 to 200 g/10 min; and
B) from 10 wt % to 50 wt %, based upon the total weight of the polypropylene composition, of a copolymer of propylene and ethylene having from 30.0 wt % to 70.0 wt %, based upon the total weight of the copolymer, of ethylene derived units; wherein the sum of the amount of component A) and B) being 100;
the polypropylene composition having:
i) an intrinsic viscosity of the fraction soluble in xylene at 25° C. between 2.2 and 4.0 dl/g;
ii) a MFR L (Melt Flow Rate according to ISO 1133, condition L, at 230° C. and 2.16 kg load) from 0.5 to 100 g/10 min; and
iii) a xylene soluble fraction ranging from 10 wt % to 50 wt %, based upon the total weight of the polypropylene composition; and
the polypropylene composition being obtained by a polymerization process including the steps of:
step a) polymerizing propylene to obtain component A) in the presence of a catalyst made from or containing the product of a reaction between:
a) a solid catalyst component made from or containing Ti, Mg, Cl, and an internal electron donor compound containing from 0.1 to 50% wt of Bi with respect to the total weight of the solid catalyst component;
b) an alkylaluminum compound and,
c) an external electron-donor compound having the formula:

(R¹)ₐSi(OR²)_{b}
wherein R¹ and R² are independently selected among alkyl radicals with 1-8 carbon atoms, optionally containing heteroatoms, and a is 0 or 1 and a+b=4; and
step b) polymerizing propylene and ethylene to obtain component B) in the presence of the polymerization product of step a).

### BRIEF DESCRIPTION OF THE DRAWINGS

FIG. 1 represents a plot of the values of the TDS analysis of examples 1 and 2 and comparative examples 3-5.

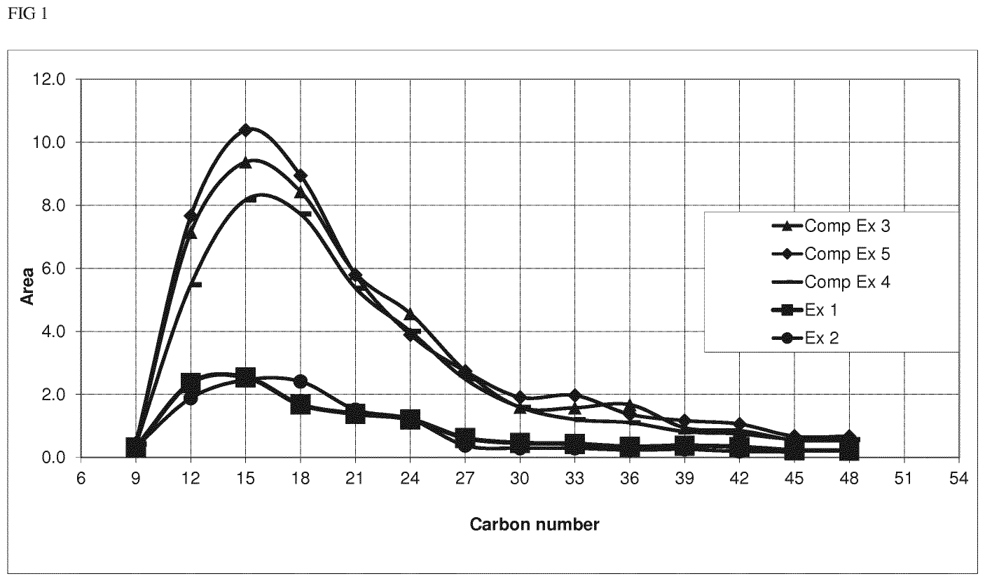

FIG. 2 represents a plot of the values of the TDS analysis of example 6 and comparative example 7.

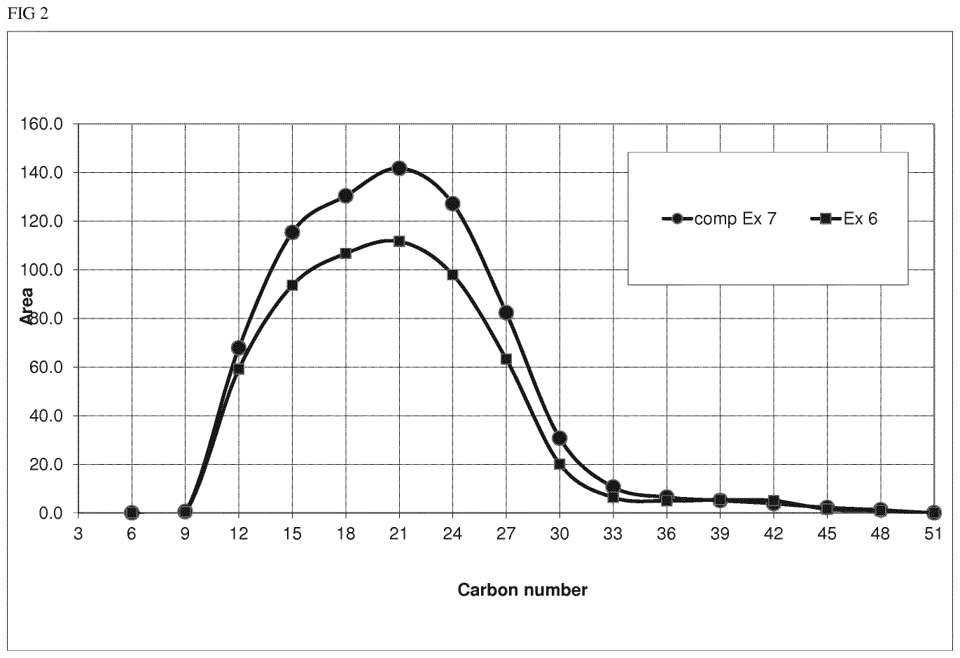

### DETAILED DESCRIPTION OF THE INVENTION

In some embodiments, the present disclosure provides a polypropylene composition made from or containing:
A) from 50 wt % to 90 wt %; alternatively from 60 wt % to 85 wt %; alternatively from 67 wt % to 82 wt %, based upon the total weight of the polypropylene composition, of a propylene homopolymer having a fraction insoluble in xylene at 25° C., higher than 90%, alternatively higher than 95%, alternatively higher than 97%; and a MFR L (Melt Flow Rate according to ISO 1133, condition L, at 230° C. and 2.16 kg load) from 0.5 to 200 g/10 min, alternatively from 50 to 150 g/10 min, alternatively from 80 to 140 g/10 min; and
B) from 10 wt % to 50 wt %; alternatively from 15 wt % to 40 wt %; alternatively from 18 wt % to 33 wt %, based upon the total weight of the polypropylene composition, of a copolymer of propylene and ethylene having from 30.0 wt % to 70.0 wt/o, alternatively from 35.0 wt % to 60.0 wt %, alternatively from 40.0 wt % to 58.0 wt %, alternatively from 45 wt % to 55%, based upon the total weight of the copolymer, of ethylene derived units;
wherein the sum of the amount of component A) and B) being 100;
the polypropylene composition having:
i) an intrinsic viscosity of the fraction soluble in xylene at 25° C. between 2.2 and 4.0 dl/g alternatively between 2.5 and 4.0 dl/g, alternatively between 2.6 and 3.5 dl/g;
ii) a MFR L (Melt Flow Rate according to ISO 1133, condition L, at 230° C. and 2.16 kg load) from 0.5 to 100 g/10 min, alternatively from 8 to 70 g/10 min, alternatively from 10 to 60 g/10 min; and
iii) a xylene soluble fraction ranging from 10 wt % to 50 wt %; alternatively from 12 wt % to 35 wt %, based upon the total weight of the polypropylene composition; and
the polypropylene composition being obtained by a polymerization process including the steps of:
step a) polymerizing propylene to obtain component A) in the presence of a catalyst made from or containing the product of a reaction between:
a) a solid catalyst component made from or containing Ti, Mg, Cl, and an internal electron donor compound containing from 0.1 to 50% wt of Bi with respect to the total weight of the solid catalyst component;
b) an alkylaluminum compound and,
c) an external electron-donor compound having the formula:

(R¹)ₐSi(OR²)_{b}
wherein R¹ and R² are independently selected among alkyl radicals with 1-8 carbon atoms, optionally containing heteroatoms, and a is 0 or 1 and a+b=4; and step b) polymerizing propylene and ethylene to obtain component B) in the presence
of the polymerization product of step a).

As used herein, the term “copolymer” refers to polymers containing two kinds of comonomers.

In some embodiments, the polypropylene composition is used for automotive interior element.

As used herein, the term “automotive interior element” refers to the interior parts of automotive, alternatively selected from the group consisting of door handles, door pockets, trim and parcel shelves, air ducts, heater/air conditioning unit casings, armatures for fascia panels, center consoles, and carpeting.

In some embodiments, the oligomer content of the polypropylene composition, measured in the ex-reactor polymer, is lower than 2000 ppm; alternatively lower than 1500 ppm.

In some embodiments, the tensile modulus of the polypropylene composition is between 800 MPa and 1600 MPa, alternatively between 850 and 1500 MPa;

In some embodiments, the present disclosure provides an automotive interior made from or containing the polypropylene composition.

In some embodiments, the polyolefin composition is prepared by a process including homopolymerizing propylene in a first stage and then copolymerizing propylene with ethylene in a second stage, wherein both stages occur in the presence of a catalyst made from or containing the product of a reaction between:
a) a solid catalyst component made from or containing Ti, Mg, Cl, and at least one electron donor compound containing from 0.1 to 50% wt of Bi with respect to the total weight of the solid catalyst component;
b) an alkylaluminum compound and,
c) an external electron-donor compound having the formula:

(R¹)ₐSi(OR²)_{b}

wherein R¹ and R² are independently selected among alkyl radicals with 1-8 carbon atoms, optionally containing heteroatoms, and a is 0 or 1 and a+b=4.

In some embodiments, in the catalyst component the content of Bi ranges from 0.5 to 40%, alternatively from 1 to 35, alternatively from 2 to 25% wt, alternatively from 2 to 20% wt, based upon the total weight of the solid catalyst component.

In some embodiments, the particles of the solid component have substantially spherical morphology and average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the amount of Mg ranges from 8 to 30%, alternatively from 10 to 25% wt, based upon the total weight of the solid catalyst component.

In some embodiments, the amount of Ti ranges from 0.5 to 5%, alternatively from 0.7 to 3% wt, based upon the total weight of the solid catalyst component.

In some embodiments, the internal electron donor compounds are selected from alkyl and aryl esters of optionally substituted aromatic polycarboxylic acids such as esters of benzoic and phthalic acids, In some embodiments, the esters are selected from the group consisting of n-butylphthalate, di-isobutylphthalate, di-n-octylphthalate, ethyl-benzoate and p-ethoxy ethyl-benzoate.

In some embodiments, the Mg/Ti molar ratio is equal to, or higher than, 13, alternatively in the range 14-40, alternatively from 15 to 40. In some embodiments, the Mg/donor molar ratio is higher than 16, alternatively higher than 17, alternatively ranging from 18 to 50.

In some embodiments, Bi atoms derive from one or more Bi compounds not having Bi-carbon bonds. In some embodiments, the Bi compounds are selected from the group consisting of Bi halides, Bi carbonate, Bi acetate, Bi nitrate, Bi oxide, Bi sulfate, and Bi sulfide. In some embodiments, the Bi compounds have valence 3+. In some embodiments, the Bi compounds are selected from the group consisting of Bi trichloride and Bi tribromide. In some embodiments, the Bi compound is BiCl₃.

In some embodiments, the solid catalyst component is prepared by reacting a titanium compound of formula Ti(OR)_{q-y}X_{y}, where q is the valence of titanium and y is a number between 1 and q with a magnesium chloride deriving from an adduct of formula MgCl₂.pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and kept at this temperature for 0.5-2 hours. In some embodiments, the temperature of the cold TiCl₄ is 0° C. In some embodiments, the treatment with TiCl₄ is carried out one or more times. In some embodiments, the electron donor compound is added during the treatment with TiCl₄.

Several ways are available to add one or more Bi compounds in the catalyst preparation. In some embodiments, a Bi compound is incorporated directly into the MgCl₂.pROH adduct during the adduct's preparation. In some embodiments, the Bi compound is added at the initial stage of adduct preparation by mixing the Bi compound together with MgCl₂ and the alcohol. In some embodiments, the Bi compound is added to the molten adduct before the emulsification step. The amount of Bi introduced ranges from 0.1 to 1 mole per mole of Mg in the adduct. In some embodiments, the Bi compounds, which are incorporated directly into the MgCl₂.pROH adduct, are Bi halides. In some embodiments, the Bi compound is BiCl₃.

In some embodiments, the alkyl-Al compound (b) is selected from the group consisting of trialkyl aluminum compounds, alkylaluminum halides, alkylaluminum hydrides and alkylaluminum sesquichlorides. In some embodiments, the alkyl-Al compound (b) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (b) is an alkylaluminum sesquichlorides selected from the group consisting of AlEt₂Cl and Al₂Et₃Cl₃. In some embodiments, the alkyl-Al compound (b) is a mixture including trialkylaluminums. In some embodiments, the Al/Ti ratio is higher than 1, alternatively between 50 and 2000.

The external electron donor compound (c) is a silicon compound having the formula

(R¹)ₐSi(OR²)_{b} (II)

wherein R¹ and R² are independently selected among alkyl radicals with 1-8 carbon atoms, optionally containing heteroatoms, wherein a is 0 or 1 and a+b=4.
In some embodiments, the silicon compounds of formula (II) are wherein a is 1, b is 3 and R¹ and R² are independently selected among alkyl radicals having 2-6, alternatively 2-4, carbon atoms. In some embodiments, the silicon compound is isobutyl triethoxysilane (iBTES).
In some embodiments, the silicon compounds of formula (II) are wherein a is 0, b is 4 and R² are independently selected among alkyl radicals with 2-6, alternatively 2-4, carbon atoms. In some embodiments, the silicon compound is tetraethoxysilane.

In some embodiments, the external electron donor compound (c) is used in an amount to give a molar ratio between the alkyl-Al compound (b) and the external electron donor compound (c) of from 0.1 to 200, alternatively from 1 to 100, alternatively from 3 to 50.

In some embodiments, the polymerization processes are carried out in gas-phase operating in one or more fluidized or mechanically agitated bed reactors, slurry polymerization using as diluent an inert hydrocarbon solvent, or bulk polymerization using the liquid monomer as a reaction medium. In some embodiments, the liquid monomer is propylene. In some embodiments, the polypropylene composition of the present disclosure is obtained with a polymerization process in two or more stages in which component A) is obtained in the first stage and then component B) is obtained in the second stage in the presence of component A).

In some embodiments, the polymerization is carried out at temperature of from 20 to 120° C., alternatively from 40 to 80° C. In some embodiments, when the polymerization is carried out in gas-phase, the operating pressure is between 0.5 and 5 MPa, alternatively between 1 and 4 MPa. In some embodiments, when the polymerization is carried out in bulk polymerization, the operating pressure is between 1 and 8 MPa, alternatively between 1.5 and 5 MPa. In some embodiments, hydrogen is used as a molecular weight regulator.

In some embodiments, the polypropylene compositions also contain additives. In some embodiments, the additives are selected from the group consisting of antioxidants, light stabilizers, heat stabilizers, nucleating agents, colorants and fillers.

In some embodiments, the automotive interior element according to the present disclosure is obtained from the polypropylene composition by injection molding or thermoforming.

The following examples are given to illustrate and not to limit the present disclosure.

### EXAMPLES

Determination of Mg, Ti

The determination of Mg and Ti content in the solid catalyst component has been carried out via inductively coupled plasma emission spectroscopy on “I.C.P Spectrometer ARL Accuris”.

The sample was prepared by analytically weighing, in a “Fluxy” platinum crucible”, 0.1÷0.3 grams of catalyst and 2 grams of lithium metaborate/tetraborate 1/1 mixture. After addition of some drops of KI solution, the crucible was inserted in a “Claisse Fluxy” for the complete burning. The residue was collected with a 5% v/v HNO₃ solution and then analyzed via ICP at the following wavelengths: Magnesium, 279.08 nm; Titanium, 368.52 nm.

Determination of Bi

The determination of Bi content in the solid catalyst component was carried out via inductively coupled plasma emission spectroscopy on “I.C.P Spectrometer ARL Accuris”.

The sample was prepared by analytically weighing in a 200 cm³ volumetric flask 0.1-0.3 grams of catalyst. After slow addition of both about 10 milliliters of 65% v/v HNO₃ solution and about 50 cm³ of distilled water, the sample underwent a digestion for 4÷6 hours. Then the volumetric flask was diluted to the mark with deionized water. The resulting solution was directly analyzed via ICP at the following wavelength: Bismuth, 223.06 nm.

Determination of Internal Donor Content

The determination of the content of internal donor in the solid catalytic compound was done through gas chromatography. The solid component was dissolved in acetone, an internal reference was added, and a sample of the organic phase was analyzed in a gas chromatograph, to determine the amount of donor present at the starting catalyst compound.

Determination of X.I. And X.S.

2.5 g of polymer and 250 cm³ of o-xylene were introduced in a glass flask equipped with a refrigerator and a magnetic stirrer. The temperature was raised in 30 minutes from room temperature up to the boiling point of the solvent (135° C.). The resulting clear solution was then kept under reflux and stirring for further 30 minutes. The closed flask was then kept in a thermostatic water bath at 25° C. for 30 minutes. The resulting solid was filtered on quick filtering paper. 100 cm³ of the filtered liquid was poured in a previously weighed aluminum container which was heated on a heating plate under nitrogen flow, to remove the solvent by evaporation. The container was then kept in an oven at 80° C. under vacuum to dryness and then weighed after constant weight was obtained. The percent by weight of polymer soluble and insoluble in xylene at 25° C. was then calculated.

### Intrinsic Viscosity (I.V.)

The sample was dissolved in tetrahydronaphthalene at 135° C. and then poured into a capillary viscometer. The viscometer tube (Ubbelohde type) was surrounded by a cylindrical glass jacket; this setup allowed for temperature control with a circulating thermostatic liquid. The downward passage of the meniscus was timed by a photoelectric device.

The passage of the meniscus in front of the upper lamp started the counter which had a quartz crystal oscillator. The meniscus stopped the counter as the meniscus passed the lower lamp and the efflux time was registered: the efflux time was converted into a value of intrinsic viscosity through Huggins' equation (Huggins, M. L., J. Am. Chem. Soc., 1942, 64, 2716) using the flow time of the pure solvent at the same experimental conditions (same viscometer and same temperature). A single polymer solution was used to determine [η].

Melt Flow Rate (MFR L)

The melt flow rate MFR L of the polymer was determined according to ISO 1133, condition L (230° C., 2.16 Kg).

¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal reference at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD to remove 1H-13C coupling. 512 transients were stored in 32K data points using a spectral window of 9000 Hz.

The assignments of the spectra, the evaluation of triad distribution and the composition were made as described in “Carbon-13 NMR determination of monomer sequence distribution in ethylene-propylene copolymers prepared with 5-titanium trichloride-diethylaluminum chloride” M. Kakugo, Y. Naito, K. Mizunuma and T. Miyatake, Macromolecules, 1982, 15, 1150, using the following equations:

| | | |
|---|---|---|
| PPP = 100 T_{ββ}/S | PPE = 100 T_{βδ}/S | EPE = 100 T_{δδ}/S |
| PEP = 100 S_{ββ}/S | PEE = 100 S_{βδ}/S | EEE = 100 (0.25 S_{γδ} + 0.5 S_{δδ})/S |

S = T_{ββ} + T_{βδ} + T_{δδ} + S_{ββ} + S_{βδ} + 0.25 S_{γδ} + 0.5 S_{δδ}

The molar percentage of ethylene content was evaluated using the following equation:

E % mol=100*[PEP+PEE+EEE]. The weight percentage of ethylene content was evaluated using the following equation:

E % mol*MW_{E}

E % wt.= . . .

E % mol*MW_{E}=P % mol*MW_{P}

where P/o mol is the molar percentage of propylene content, while MW_{E} and MW_{P} are the molecular weights of ethylene and propylene, respectively.

The product of reactivity ratio r₁r₂ was calculated according to C. J. Carman, R. A. Harrington and C. E. Wilkes, Macromolecules, 1977; 10, 536 as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

The ethylene content of component B) was calculated from the total ethylene content by using the formula: Ethylene(B wt %)=Ethylene(tot wt %)/(amount B wt %)/100).

Tensile Modulus

Tensile Modulus was measured according to ISO 527-2, and ISO 1873-2

Oligomer Content

The determination of oligomer content by solvent extraction consisted of treating 5 g of polypropylene sample with 10 ml of methylenedichloride (CH₂Cl₂) in an ultrasonic bath at 25° C. for 4 hours. 1 μl of the extracted solution was injected into capillary column and analyzed by using FID, without any filtration. For quantitative estimation ofoligomer content, a calibration based on external standard method was applied. A series of hydrocarbon (C12-C22-C28-C40) was used.

TDS Analysis

An amount of polymer between 0.10 and 0.15 g was loaded in an open glass tube (177 mm length, 6 mm external diameter, 4 mm internal diameter) which was then inserted into a TDS3 thermodesorber (Gerstel, Mülheim an der Ruhr, Germany) mounted on an Agilent GC-6890N (Agilent Technologies, Billerica, Mass., USA) chromatograph equipped with a MS-5973N mass spectrometry detector (electron multiplier of 1500, MS range from 29 to 800). The instruments carried a PTV injector and a HP-5msUI Part N^{o}19091S-436UI (Agilent Technologies) chromatographic column (60 m length, 0.25 mm internal diameter, 0.10 micron film thickness) in the oven.

The temperature of the thermodesorber was raised from 40 to 280° C. at a rate of 60 C°/min and then kept at 280° C. for 15 min while the injector was refrigerated at −50° C. by liquid nitrogen to extract oligomers, additives and their by-products. The process occurred in ultrapure helium to provide an oxygen-free atmosphere. The desorbed substances were then injected into the column. The temperature of the oven varied from 40° C. (5 min isothermal step) to 320° C. with a rate of 6C°/min during the elution, which took 101.67 min. The carrier gas was ultrapure helium, at a constant flow rate of 0.7 mL/min. The chromatogram was acquired in full scan mode, total ion current (TIC). Evaluation was performed though Agilent ChemStations software.

### Examples 1 and 2

Procedure for the Preparation of the Spherical Adduct

Microspheroidal MgCl₂.pC₂H₅OH adduct was prepared according to the method described in Comparative Example 5 of Patent Cooperation Treaty Publication No. WO98/44009, with the difference that BiCl₃ in a powder form and in the amount of 3 mol % with respect to the magnesium being added before feeding of the oil.

Procedure for the Preparation of the Solid Catalyst Component

Into a 500 ml round bottom flask, equipped with mechanical stirrer, cooler and thermometer, 300 ml of TiCl₄ were introduced at room temperature under nitrogen atmosphere. After cooling to 0° C., while stirring, diisobutylphthalate and 9.0 g of the spherical adduct were sequentially added into the flask. The amount of charged internal donor was to meet a Mg/donor molar ratio of 8. The temperature was raised to 100° C. and maintained for 2 hours. Thereafter, stirring was stopped, the solid product was allowed to settle and the supernatant liquid was siphoned off at 100° C. After the supernatant was removed, additional fresh TiCl₄ was added to reach the initial liquid volume again. The mixture was then heated at 120° C. and kept at this temperature for 1 hour. Stirring was stopped again, the solid was allowed to settle and the supernatant liquid was siphoned off. The solid was washed with anhydrous hexane six times in temperature gradient down to 60° C. and one time at room temperature. The solid was then dried under vacuum and analyzed.

Prepolymerization Treatment

Before introducing the solid catalyst component into the polymerization reactors, the solid catalyst component was contacted with triethyl aluminum (TEAL) and isobutyl-triethoxysilane (iBTES) or tetraethoxysilane (TEOS) as reported in Table 1.

Polymerization

The polymerization run was carried out in continuous mode in a series of two reactors equipped with devices to transfer the product from a first reactor to a second reactor immediately next to the first reactor. The first reactor was a liquid phase loop reactor, and the second reactor was a fluidized bed gas-phase reactor. A propylene homopolymer was prepared in the liquid loop reactor while a propylene ethylene copolymer was prepared in the gas-phase reactor in the presence of the propylene homopolymer coming from the first reactor. Hydrogen was used as molecular weight regulator.

The gas phase (propylene, ethylene and hydrogen) was continuously analyzed via gas-chromatography.

At the end of the run, the powder was discharged and dried under a nitrogen flow.

The main polymerization conditions and the analytical data relating to the polymers produced in the reactors are reported in Table 1. Properties of the polymer are reported in Table 2.

### Comparative Examples 3-5

Preparation of the Solid Catalyst Component

The catalysts of comparative examples 3-5 were produced by using the same method used for preparing the catalyst of example 1 but using methylcyclohexyldimethoxysilane (C donor) or dicyclopentyldimethoxysilane (D donor) as reported in Table 1.

Prepolymerization Treatment

Prepolymerization treatment was carried out according to the procedure of example 1.

Polymerization

The polymerization was carried out by using the same procedure of example 1. The main polymerization conditions and the analytical data relating to the polymers produced in the reactors are reported in Table 1. Properties of the polymer are reported in Table 2.

TABLE 1

| PROCESS | | | comp | comp | comp |
|---|---|---|---|---|---|
| CONDITIONS | Ex1 | Ex2 | Ex3 | Ex4 | Ex5 |
| Precontact | | | | | |
| Temperature, ° C. | 12 | 12 | 12 | 12 | 12 |
| Residence time, | 17 | 14 | 20 | 14 | 20 |
| min | | | | | |
| external donor, | iBTES | TEOS | C | C | D |
| type | | | | | |
| Teal/donor weight | 10 | 10 | 6 | 5 | 24 |
| ratio, g/g | | | | | |
| Prepolymerization | | | | | |
| Temperature, ° C. | 20 | 20 | 20 | 20 | 20 |
| Residence time, | 7 | 7 | 7 | 7 | 7 |
| min | | | | | |
| Loop 1^{st} reactor | | | | | |
| in liquid | | | | | |
| phase - propylene | | | | | |
| homopolymer | | | | | |
| Temperature, ° C. | 70 | 70 | 70 | 70 | 70 |
| Pressure, barg | 40 | 40 | 40 | 40 | 40 |
| Residence time, | 58 | 65 | 61 | 63 | 61 |
| min | | | | | |
| [H2] feed conc, | 1408 | 722 | 3230 | 3312 | 6272 |
| ppm | | | | | |
| Split, wt % | 75 | 75 | 75 | 74 | 73 |
| Gas-Phase reactor | | | | | |
| ethylene/propylene | | | | | |
| copolymerization | | | | | |
| Temperature, ° C. | 80 | 80 | 80 | 80 | 80 |
| Pressure, barg | 13 | 13 | 16 | 16 | 13 |
| Residence time, | 20 | 8 | 39 | 44 | 2.6 |
| min | | | | | |
| H2/C2, mol/mol | 0.068 | 0.055 | 0.063 | 0.065 | 0.1 |
| C2/C2 + C3, | 0.41 | 0.41 | 0.38 | 0.44 | 0.5 |
| mol/mol | | | | | |
| Split wt % | 25 | 25 | 25 | 26 | 27 |

C2— = ethylene; C3— = propylene; H2 = hydrogen

TABLE 2

| | | Example | | | | |
|---|---|---|---|---|---|---|
| | | | | comp | comp | comp |
| | | Ex1 | Ex2 | Ex3 | Ex4 | Ex5 |
| Component A) | | | | | | |
| Homopolymer content | % | 74 | 75 | 73 | 73 | 73 |
| MFR “L” | g/10′ | 50 | 45 | 68 | 60 | 63 |
| Xylene soluble fraction | wt % | 18 | 2.6 | 2.5 | 1.2 | 1.4 |
| Component B) | | | | | | |
| Copolymer content* | wt % | 26 | 25 | 27 | 27 | 27 |
| Property of the composition | | | | | | |
| Ethylene content | wt % | 13.8 | 13.4 | 15 0 | 13.7 | 14.1 |
| Intrinsic viscosity of the | dl/g | 2.73 | 2.87 | 2.76 | 2.98 | 2.60 |
| Xylene soluble fraction | | | | | | |
| Xylene -soluble fraction | wt % | 2 3 | 22.6 | 22.9 | 23.4 | 22.9 |
| MFR | g/10′ | 19.1 | 17.9 | 15.5 | 16.7 | 18.6 |
| tensile Modulus | MPa | 930 | 970 | 900 | 930 | 1030 |
| Oligomer content | ppm | 1240 | 695 | 1875 | 1700 | 2690 |

*calculated

From table 2 results that the oligomer content of the propylene composition obtained according to the present disclosure are considerably lower than that one of comparative examples obtained by using a different external donor.

### Example 6

Procedure for the Preparation of the Spherical Adduct

Microspheroidal MgCl₂.pC₂H₅OH adduct was prepared according to the method described in Comparative Example 5 of Patent Cooperation Treaty Publication No. WO98/44009, with the difference that BiCl₃ in a powder form and in the amount of 3 mol % with respect to the magnesium being added before feeding of the oil.

Procedure for the Preparation of the Solid Catalyst Component

Into a 500 ml round bottom flask, equipped with mechanical stirrer, cooler and thermometer, 300 ml of TiCl₄ were introduced at room temperature under nitrogen atmosphere. After cooling to 0° C., 9.0 g of the spherical adduct were added while stirring, then diethyl 3,3-dipropylglutarate was sequentially added into the flask. The amount of charged internal donor was to meet a Mg/donor molar ratio of 13. The temperature was raised to 100° C. and maintained for 2 hours. Thereafter, stirring was stopped, the solid product was allowed to settle and the supernatant liquid was siphoned off at 100° C.

After siphoning, fresh TiCl₄ and an amount of 9,9-bis(methoxymethyl)fluorene to have a Mg/diether molar ratio of 13 were added. The mixture was then heated at 120° C. and kept at this temperature for 1 hour under stirring. Stirring was stopped again, the solid was allowed to settle and the supernatant liquid was siphoned off. The solid was washed with anhydrous hexane six times in temperature gradient down to 60° C. and one time at room temperature. The solid was then dried under vacuum and analyzed.

Prepolymerization Treatment

Before introducing the solid catalyst component into the polymerization reactors, the solid catalyst component was contacted with triethyl aluminum (TEAL) and isobutyl-triethoxysilane (iBTES) in a ratio reported in Table 3.

Polymerization

The polymerization run was carried out as for example 1. Properties of the polymer are reported in Table 4.

### Comparative Example 7

Preparation of the Solid Catalyst Component

The catalysts of comparative example 7 were produced by using the same method used of the catalyst of example 6.

Prepolymerization Treatment

Before introducing the solid catalyst component into the polymerization reactors, the solid catalyst component was contacted with triethyl aluminum (TEAL) as reported in Table 3.

Polymerization

The polymerization was carried out by using the same procedure of example 5. The main polymerization conditions and the analytical data relating to the polymers produced in the reactors are reported in Table 3. Properties of the polymer are reported in Table 4.

TABLE 3

| PROCESS | | Comp |
|---|---|---|
| CONDITIONS | Ex 5 | ex 6 |
| Precontact | | |
| Temperature, ° C. | 12 | 12 |
| Residence time, min | 16 | 18 |
| External donor, type | iBTES | C |
| Teal/donor, g/g | 4 | 5 |
| Prepoymerization | | |
| Temperature, ° C. | 20 | 20 |
| Residence time, min | 6 | 6 |
| Loop 1^{st} reactor in | | |
| liquid phase-propylene | | |
| homopolymer | | |
| Temperature, ° C. | 70 | 70 |
| Pressure, barg | 40 | 40 |
| Residence time, min | 74 | 68 |
| [H2] feed conc, ppm | 3689 | 5890 |
| Gas-Phase reactor - | | |
| ethylene/propylene | | |
| copolymerization | | |
| Temperature, ° C. | 80 | 80 |
| Pressure, barg | 15 | 14 |
| Residence time, min | 14 | 19 |
| H2/C2, mol/mol | 0.06 | 0.08 |
| C2/C2 + C3, mol/mol | 0.39 | 0.47 |

TABLE 4

| | | Ex 5 | Comp ex 6 |
|---|---|---|---|
| External Donor | Type | IBTES | C |
| Component A) | | | |
| Homopolymer content | % | 86 | 85 |
| MFR | g/10′ | 130 | 140 |
| XS | % | 1.7 | 1.4 |
| Component B) | | | |
| Copolymer content* | % | 14 | 15 |
| Property of the | | | |
| composition | | | |
| Ethylene content | wt % | 6.7 | 7.0 |
| Xylene-soluble fraction | % | 12.8 | 14.1 |
| Intrinsic viscosity of the | dl/g | 2.74 | 2.37 |
| Xylene soluble fraction | | | |
| MFR | g/10′ | 64.0 | 67.8 |
| Tensile Modulus | MPa | 1410 | 1480 |
| Oligomers | ppm | 1470 | 1660 |

What is claimed is:

1. A polypropylene composition comprising:
A) from 50 wt % to 90 wt %, based upon the total weight of the polypropylene composition, of a propylene homopolymer having a fraction insoluble in xylene at 25° C., higher than 90%; and a MFR L (Melt Flow Rate according to ISO 1133, condition L, at 230° C. and 2.16 kg load) from 0.5 to 200 g/10 min; and
B) from 10 wt % to 50 wt %, based upon the total weight of the polypropylene composition, of a copolymer of propylene and ethylene having from 30.0 wt % to 70.0 wt %, based upon the total weight of the copolymer, of ethylene derived units;
wherein the sum of the amount of component A) and B) being 100;
the polypropylene composition having:
i) an intrinsic viscosity of the fraction soluble in xylene at 25° C. between 2.2 and 4.0 dl/g;
ii) a MFR L (Melt Flow Rate according to ISO 1133, condition L, at 230° C. and 2.16 kg load) from 0.5 to 100 g/10 min; and
iii) a xylene soluble fraction ranging from 10 wt % to 50 wt %, based upon the total weight of the polypropylene composition; and
the polypropylene composition being obtained by a polymerization process including the steps of:
step a) polymerizing propylene to obtain component A) in the presence of a catalyst comprising the product of a reaction between:
a) a solid catalyst component comprising Ti, Mg, Cl, and an internal electron donor compound containing from 0.1 to 50% wt of Bi with respect to the total weight of solid catalyst component;
b) an alkylaluminum compound and,
c) an external electron-donor compound having the formula:
(R¹)ₐSi(OR²)_{b}
wherein R¹ and R² are independently selected among alkyl radicals with 1-8 carbon atoms, optionally containing heteroatoms, and a is 0 or 1 and a+b=4; and
step b) polymerizing propylene and ethylene to obtain component B) in the presence of the polymerization product of step a).

2. The polypropylene composition according to claim 1, wherein component A) ranges from 60 wt % to 85 wt % and component B) ranges from 15 wt % to 40 wt %.

3. The polypropylene composition according to claim 1, wherein component B) contains from 35.0 wt % to 60.0 wt % of ethylene derived units.

4. The polypropylene composition according to claim 1, wherein the a MFR L (Melt Flow Rate according to ISO 1133, condition L, at 230° C. and 2.16 kg load) ranges from 8 to 70 g/10 min:

5. The polypropylene composition according to claim 1, wherein the xylene soluble fraction ranges from 25-12 wt % to 35 wt %.

6. The polypropylene composition according to claim 1, wherein the external electron-donor compound having the formula (R¹)ₐSi(OR²)_{b}, a is 1, b is 3 and R¹ and R² are independently selected among alkyl radicals having 2-6 carbon atoms.

7. The polypropylene composition according to claim 1, wherein the external electron-donor compound having the formula (R¹)ₐSi(OR²)_{b}, a is 0, b is 4, and the R² groups are independently selected from the alkyl radicals having 2-6 carbon atoms.

8. The polypropylene composition according to claim 1, wherein the external electron-donor compound is isobutyl triethoxysilane.

9. The polypropylene composition according to claim 1, wherein the external electron-donor compound is tetraethoxysilane.

10. An automotive interior element comprising:
the polypropylene composition of claim 1.
